(19) United States
(12) Patent Application Publication
(10) Pub. No.: US 2026/0338020 A1
(43) Pub. Date: Oct. 29, 2026

(54) DOOR OPENING AND CLOSING DEVICE AND ELECTRICAL APPARATUS

(71) Applicants: HEFEI MIDEA REFRIGERATOR CO., LTD., HEFEI (CN); HEFEI HUALING CO., LTD., HEFEI (CN); MIDEA GROUP CO., LTD., FOSHAN (CN)

(72) Inventors: Bo PENG, HEFEI (CN); Zhuohua JIANG, HEFEI (CN); Yafei ZHU, HEFEI (CN); Yerui FENG, HEFEI (CN); Bing SHI, HEFEI (CN); Chuandong WANG, HEFEI (CN); Shenghao QI, HEFEI (CN); Jinguo YUAN, HEFEI (CN); Xiuliang FU, HEFEI (CN)

(21) Appl. No.: 19/111,760

(22) PCT Filed: Jun. 26, 2023
(86) PCT No.: PCT/CN2023/102389

§ 371 Date: Mar. 13, 2025

(30) Foreign Application Priority Data
Sep. 20, 2022 (CN) 202211145453.4

(51) Int. Cl. E05F 15/614; E05F 5/02; E05F 15/616; E05F 15/63

(52) U.S. Cl. CPC E05F 15/614; E05F 5/027; E05F 15/616; E05F 15/63; E05Y 2201/686; E05Y 2201/71

(57) ABSTRACT

The door opening and closing device comprises: a driving mechanism, a door rotation mechanism, a door ejection mechanism and a suspension mechanism. The driving mechanism includes a linkage wheel. The linkage wheel is rotatably disposed on a base. A limit groove is disposed on a peripheral surface of the linkage wheel. The limit groove has a door ejection surface along a peripheral surface direction of the linkage wheel. The door rotation mechanism is connected to the linkage wheel and the door body. The door ejection mechanism includes a door ejection member movably disposed on the base. The suspension mechanism is movably disposed on the base.

### CROSS-REFERENCES TO RELATED APPLICATIONS

The present disclosure is a national phase application of International Application No. PCT/CN2023/102389, filed on Jun. 26, 2023, which claims priority to the Chinese patent application No. 202211145453.4, filed on Sep. 20, 2022, the entire contents of which are incorporated herein by reference.

### FIELD

The disclosure belongs to the field of electrical apparatus, and in particular to a door opening and closing device and an electrical apparatus.

### BACKGROUND

With the improvement of living standards, electrical apparatuses such as refrigerators, dishwashers and disinfection cabinets have become widely used in lives of people. In order to maintain a sealing performance of the above-mentioned electrical apparatuses, an adsorption structure is usually provided between a box body and a door body thereof or negative pressure is maintained within the box body, to stably fix the door body on the box body. Although a related performance of the electrical apparatus is improved in this way, a difficulty of opening the door body is also increased to a certain extent. Since a larger force is usually required to open the door body, it is inconvenient to use. To this end, a door opening and closing device can be provided to implement operations of opening and closing a door to reduce a difficulty of operations of door opening and closing.

In the related art, in order to avoid interferences of operations, after the door body reaches a preset opening, the door opening and closing device will stop outputting a driving force. Under an influence of safety measures of the door body or influences of factors such as ground unevenness and the like, the door body will be rotated toward a direction enclosing the box body, and thus cannot maintain in a door open state, to cause an inconvenience in use and even create certain safety risks.

### SUMMARY

A door opening and closing device and an electrical apparatus are provided according to one or more embodiments of the disclosure, aiming to at least to some extent solve a problem that the door opening and closing device of the electrical apparatus after being shut down cannot maintain an open door state. To this end, according to one embodiment of the disclosure, a door opening and closing device is provided. The door opening and closing device may include: a driving mechanism, a door rotation mechanism, a door ejection mechanism, and a suspension mechanism;
the driving mechanism includes a linkage wheel. The linkage wheel is rotatably disposed on a base. A limit groove is disposed on a peripheral surface of the linkage wheel. The limit groove has a door ejection surface along a direction of peripheral surface of the linkage wheel;
the door rotation mechanism is connected to the door body;
the door ejection mechanism includes a door ejection member which is movably disposed on the base;
the suspension mechanism is movably disposed on the base;
in a condition that the door body is closed, an end of the door ejection member is located in the limit groove, and the suspension mechanism is abutted against and held on the peripheral surface of the linkage wheel.

In a condition that the linkage wheel is rotated, the linkage wheel pushes, through the door ejection surface, the door ejection member to move relative to the base to push the door body, and then drives the door rotation mechanism to continue to rotate the door body. An end of the suspension mechanism slides along the peripheral surface of the linkage wheel, and thus when the suspension mechanism slides into the limit groove, the suspension mechanism is abutted against and held in the limit groove to provide an acting force to brake the rotation of the linkage wheel.

According to another embodiment of the disclosure, an electrical apparatus is provided, including: a box body, a door body and a door opening and closing device. The door body is rotatably connected to the box body, and the door opening and closing device is connected to the box body and connected to the door body, to open or close the door body and achieve a suspension of the door body when rotating to a preset position.

### BRIEF DESCRIPTION OF THE DRAWINGS

In order to more clearly illustrate the embodiments of the disclosure, the following briefly introduces the accompanying drawings required for describing the embodiments. The accompanying drawings in the following description only illustrate some embodiments of the disclosure, and other accompanying drawings can also be obtained based on these accompanying drawings.

FIG. 1 shows a schematic structural diagram of a door opened and suspended state of a door opening and closing device according to some embodiments of the disclosure;

FIG. 2 is a schematic structural diagram showing a door closed state of the door opening and closing device in FIG. 1;

FIG. 3 shows a schematic structural diagram of a suspension mechanism of the door opening and closing device in FIG. 1;

FIG. 4 shows a schematic structural diagram of a linkage wheel of the door opening and closing device in FIG. 1;

FIG. 5 shows a schematic structural diagram of a suspension member and an ejection-push member of the door opening and closing device in FIG. 1;

FIG. 6 shows a schematic structural diagram of a suspension limit slide slot of the door opening and closing device in FIG. 1;

FIG. 7 is a schematic structural diagram showing an assembly of the suspension member and the suspension limit slide slot of the door opening and closing device in FIG. 1;

FIG. 8 is a schematic structural diagram showing an initial state of the door opening and closing device in FIG. 1;

FIG. 9 is a schematic structural diagram showing a door ejection state of the door opening and closing device in FIG. 1;

FIG. 10 is a schematic structural diagram showing a suspended state of the door opening and closing device in FIG. 1; and

FIG. 11 shows a schematic structural diagram of the door ejection mechanism of the door opening and closing device in FIG. 10.

In the accompanying drawings, corresponding relationships between reference signs and component names are as follows:
12, box body; 13, door body;
200, driving mechanism;
300, linkage wheel; 310, rotation center; 320, limit groove; 322, door ejection surface; 324, avoidance surface; 326, connection point; 328, jointing surface; 329, fix groove; 329a, first abutting-holding surface; 329b, second abutting-holding surface;
400, door rotation mechanism; 410, front connecting rod; 420, rear connecting rod; 431, first connection point; 432, second connection point; 433, third connection point;
500, door ejection mechanism; 510, elastic member; 520, door ejection member;
600, suspension mechanism; 610, suspension member; 611, ejecting-abutting portion; 612, push-ejection limit slot; 620, ejection-push member;
900, base; 906, suspension limit slide slot; 907, limit boss; 908, support socket; 909, boss portion; 912, mounting groove.

### DETAILED DESCRIPTION OF THE DISCLOSURE

The embodiments of the disclosure will be clearly and completely described below with reference to the accompanying drawings in the embodiments of the disclosure. The described embodiments are only some embodiments, rather than all embodiments of the disclosure. Based on the embodiments in the disclosure, all other embodiments obtained fall within the protection scope sought by the disclosure.

Furthermore, the disclosure may repeat reference numerals and/or reference letters in different examples. Such repetition is for the purpose of simplicity and clarity and does not in itself indicate a relationship between the various embodiments and/or settings discussed. Furthermore, the disclosure provides examples of various specific processes and materials, but it may be recognized the application of other processes and/or the use of other materials.

Embodiments of the disclosure are described below with reference to the accompanying drawings and embodiments.

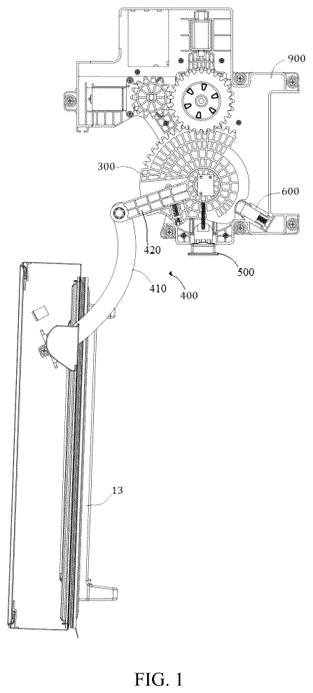

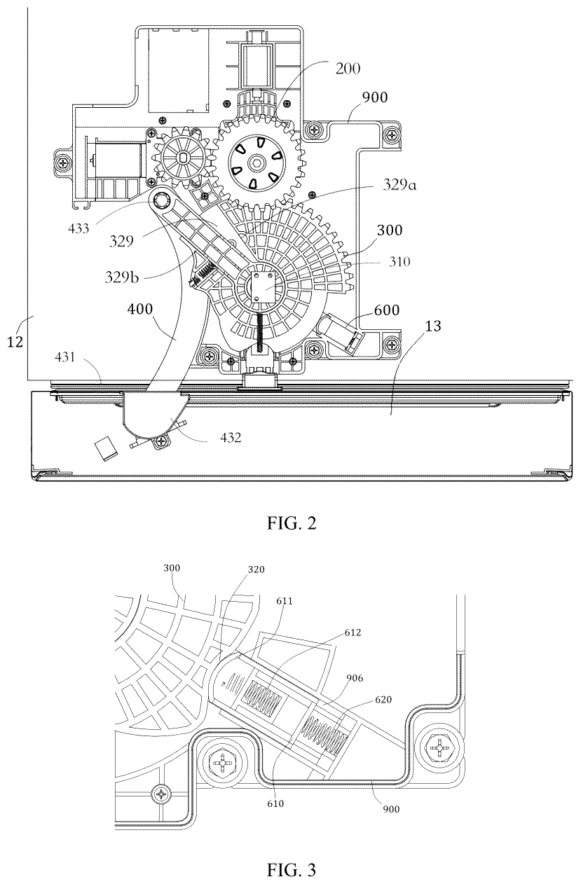

As shown in FIG. 1 and FIG. 2, a door opening and closing device is provided according to an embodiment of the disclosure. The door opening and closing device is mounted to a box body 12 of an electrical apparatus and is connected to a door body 13 of the electrical apparatus. The door opening and closing device drives the door body 13 to deflect relative to the box body 12, to close and open the box body 12, and thus a convenience of operation is improved. The door opening and closing device can also maintain the door body 13 at a position with a preset opening after the door body 13 reaches the preset opening, to facilitate taking or storing items in the box body 12. Therefore, a comfortability of use is improved and a safety risk of collision caused by the door body deflecting and closing can be avoided.

The door opening and closing device according to an embodiment of the disclosure can be mainly used on an electrical apparatus to automatically open or close the door body 13. The door opening and closing device, after receiving a door opening signal, can automatically open the door body 13. The door opening signal may be triggered by a user or by the electrical apparatus itself. Likewise, the door opening and closing device, after receiving a door closing signal, can automatically close the door body 13. In an embodiment, the door opening signal may be triggered by a user or by the electrical apparatus itself.

In an embodiment of the disclosure, the door opening and closing device may include: a door rotation mechanism 400 and a driving mechanism 200. The driving mechanism includes a linkage wheel 300. The linkage wheel 300, as a transmission component for a driving force, is rotatably disposed on the base 900 or the box body 12, and is connected to an upstream driving device to obtain the driving force and transmit the driving force by rotation. The linkage wheel 300 is also connected to the door rotation mechanism 400, and the door rotation mechanism 400 is connected to the door body 13, and thus the door rotation mechanism 400 can be driven to act by a rotation of the linkage wheel 300, to make the door body 13 to rotate to implement operations of door opening and closing. In an embodiment of the disclosure, by providing a door ejection mechanism 500, a door rotation mechanism 400 and a linkage wheel 300, the door body 13 can be rotated to realize automatic door opening and closing, to reduce a difficulty of manual operation of door opening. Therefore, a convenience and comfortability of operations of door opening and closing can be improved.

When the door body 13 is rotated to a position with a preset opening, the linkage wheel 300 will no longer drive the door rotation mechanism 400 to act, and a driving force will be stopped from applying to the linkage wheel 300 to keep the door body 13 at current position, that is, a driving relationship between the door body 13 and the upstream driving device is broken off, to avoid an interference with manual operation of the door body 13, and thus to facilitate a manual operation of the door body 13. However, a center of gravity of the door body is caused to be shifted due to items stored on the door body 13 of an electrical apparatus such as a refrigerator, or a tilted placement of the refrigerator, which can result in an autonomous deflection of the door body 13, and the door body 13 cannot maintain an opening. Thus, it is inconvenient to use and even causes a safety risk of collision to an operator.

As shown in FIG. 2 and FIG. 3, in order to solve a problem that the door body 13 cannot maintain an opening when the door opening and closing device is shut down, a limit groove 320 may be formed on the linkage wheel 300, and a suspension mechanism 600 may be disposed on the base 900. When the limit groove 320 of the linkage wheel 300 is rotated to be opposite to the suspension mechanism 600, the suspension mechanism 600 moves relative to the base 900 and then ejects and abuts against the limit groove 320, to lock the linkage wheel 300 on the base 900, to prevent the door rotation mechanism 400 from rotating the door body 13, to achieve a suspension of the door body 13 and maintain a position with preset opening.

That is to say, the limit groove 320 is rotated with the linkage wheel 300. The suspension mechanism 600 can move relative to the base 900, and can change a movement state of the suspension mechanism 600 in response to a rotation of the linkage wheel 300. Thus, when the limit groove 320 is rotated to a position where the limit groove 320 matches with and is opposite to the suspension device 600, the suspension device 600 can eject and abut against, and clamp the limit groove 320, to lock the linkage wheel 300 and limit a rotation of the linkage wheel 300, and thus the door rotation mechanism 400 can be braked to prevent the door body 13 from deflecting, to keep the door body 13 to be suspended at a preset position.

It is worth mentioning that a state of ejecting and abutting against for locking of the suspension mechanism 600 and the limit groove 320 is a reversible state. When an external driving force applied to the linkage wheel 300 is greater than a braking force between the suspension mechanism 600 and the limit groove 320, the linkage wheel 300 is enabled to break through an action of ejecting and abutting against for limiting, and thus the linkage wheel 300 goes on to be rotated and to be released from a braking state, to be capable of driving the door rotation mechanism 400 to rotate the door body 13 to be closed, or further expanding an opening of the door body 13.

As shown in FIG. 3 and FIG. 5, the suspension mechanism 600 may include a suspension member 610 and an ejection-push member 620. The suspension member 610 is movably disposed on the base 900, and continuously ejects and abuts against the linkage wheel 300, and can match with, eject and abut against, and clamp the limit groove 320, and thus when the linkage wheel 300 makes the limit groove 320 in a state opposite to the suspension member 610, the suspension member 610 can move toward the linkage wheel 300 and eject and abut against the limit groove 320, to lock the linkage wheel 300 on the base 900 to achieve a braking of the linkage wheel 300. The ejection-push member 620, as a driving element of the suspension member 610, continuously provides a pushing and ejecting force to the suspension member, to push and eject the suspension member 610 toward the linkage wheel 300, to be capable of pushing and ejecting the suspension member 610 and the limit groove 320 to eject and abut against the linkage wheel 300 for braking.

It should be noted that, the suspension member 610, under an action of continuous pushing and ejecting force, always maintains a state of abutting against the linkage wheel 300. During a rotation of the linkage wheel 300, the suspension member 610 slides on the linkage wheel 300. Only in a condition that the linkage wheel 300 is rotated to a state in which the limit groove 320 is opposite to the suspension mechanism 600, the suspension member 610 moves, and ejects and abuts into the limit groove 320 under the action of the pushing and ejecting force, to brake the linkage wheel 300. The continuous pushing and ejecting force enable the suspension member 610 to track a position of rotating peripheral surface of the linkage wheel 300 and respond to a rotating state of the limit groove 320 in a timely manner. That is, after the limit groove 320 and the suspension mechanism 600 are in corresponding positions, the suspension member 610 immediately ejects and abuts against and clamps the limit groove 320. An ejecting-abutting portion 611 may be disposed on the suspension member 610 for contacting, ejecting and abutting against the limit groove 320, and may be ejected and abutted into an interior of the limit groove 320 to implement contacting, ejecting and abutting for braking.

As shown in FIG. 5, in some embodiments, the limit groove 320 may be configured as a groove located on a peripheral surface of the linkage wheel 300. Accordingly, the ejecting-abutting portion 611 of the suspension member 610 may be configured as a protruding portion that matches with a groove shape of the groove and ensures that the ejecting-abutting portion 611 can be snapped and embedded into the groove and disengaged from the groove, to facilitate a smooth clamping for braking of the ejecting-abutting portion 611 and a releasing from braking of the ejecting-abutting portion 611.

It is worth noting that a notch of the groove may be provided with a jointing surface 328 for smoothly jointing to a peripheral surface of the linkage wheel 300, to facilitate the ejecting-abutting portion 611 to slide smoothly into the groove relative to the peripheral surface of the linkage wheel 300 and be smoothly disengaged from the groove, and thus the braking and a releasing from braking can be both achieved smoothly and stably.

In some embodiments, a groove shape of the groove may be configured to be C-shaped or V-shaped, and accordingly, the ejecting-abutting portion 611 may also be configured to be an embeddable arc-shaped or spire-shaped structure.

In order to facilitate the ejecting-abutting portion 611 to be smoothly disengaged from the groove, a certain gap may be left between the ejecting-abutting portion 611 and the groove, that is, when the ejecting-abutting portion 611 is snapped and embedded in the groove, a portion of the ejecting-abutting portion 611 is ejected and abutted against an inner wall of the groove 320a, and a gap is formed between another portion of the ejecting-abutting portion 611 and a groove wall of the groove. Therefore, under a premise of ensuring a clamping of the ejecting-abutting portion 611 and the groove 320a, the ejecting-abutting portion 611, when subjected to a force slightly greater than the pushing and ejecting force, can also be smoothly disengaged.

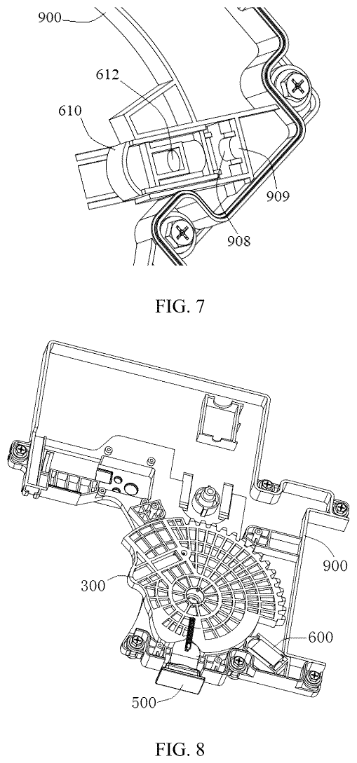

As shown in FIG. 3 and FIG. 7, in some embodiments, it is considered that a stability of the pushing and ejecting force and a stability of acting effect of the pushing and ejecting force have a positive effect on a braking performance of the ejecting-abutting portion 611. A push-ejection limit slot 612 may be formed on the suspension member 610, and the ejection-push member 620 may be disposed in the push-ejection limit slot 612, to maintain a relatively stable connection state between the ejection-push member 620 and the suspension member 610. Thus, an amplitude of relative swing between the ejection-push member 620 and the suspension member 610 can be reduced to a certain extent, to maintain stabilities of a direction of subjected force, a movement direction of the ejecting-abutting portion 611, and a contact area between the ejecting-abutting portion 611 and the limit groove 320, to ensure a braking effect. The ejection-push member 620 may also be directly connected to the ejecting-abutting portion 611 to concentrate an action point of the pushing and ejecting force on the ejecting-abutting portion 611, to reduce a risk of directional deviation of the pushing and ejecting force and an unstable ejecting-abutting effect due to changes in postures of the suspension member 610 itself.

It is worth noting that specifications of sizes of the push-ejection limit slot 612 and the ejection-push member 620 may be designed to match with one another. The width of the push-ejection limit slot 612 may be slightly larger than a width of the ejection-push member 620, to reduce a space for relative swing to maintain a stability of direction of the pushing and ejecting force.

In some embodiments, a push-ejection limit slot 612 may be configured as a blind hole along a direction of the pushing and ejecting force and capable of accommodating the ejection-push member 620. A bottom of the push-ejection limit slot 612 is disposed on the ejecting-abutting portion 611 to form a limit along a peripheral direction for the ejection-push member 620, to limit a swing amplitude in the peripheral direction, reduce a risk of the suspension member 610 bouncing up under force, and ensure a stability of position and posture of ejection.

In some embodiments, an ejecting-abutting portion 611 is disposed at an end of the suspension member 610 for contacting, ejecting and abutting against the limit groove 320. A connecting portion may also be disposed at another end of the suspension member 610 for connecting the ejection-push member 620. Thus, a molding and processing of the suspension member can be facilitated, and a flow of processing can be simplified.

In some embodiments, the ejection-push member 610 may be configured as an elastic member, and thus a continuous and successive pushing and ejecting force is applied through an elastic deformation of the elastic member, to ensure that the suspension member 610 responds to position changes of rotation of the linkage wheel 300 with a simple structure and high time efficiency, and can be quickly ejected and abutted into the limit groove 320 when the limit groove 320 is in place. At the same time, a stability of the elastic deformation of the elastic member enables the pushing and ejecting force applied to the suspension member 610 to maintain a stable state. On the one hand, a stability of a suspended state can be maintained, and on the other hand, the linkage wheel 300 can also be enabled to be rotated to release a braking state under an action of a relatively stable and controllable driving force, to achieve a stability, a reliability of a suspension function and a performance for smooth implementation of the suspension function of the door opening and closing device.

It is considered that a deformation of the elastic member can be divided into a compressed deformation and a stretched deformation. The elastic member should be assembled in a way which can maintain a relatively stable and linear deformation state of the elastic member.

When the elastic member in a compressed state provides an elastic pushing and ejecting force, the suspension member 610 may be disposed between the elastic member and a peripheral surface of the linkage wheel 300. The elastic member is compressed and disposed between the base 900 and the suspension member 610, and a reset direction of deformation of the elastic member 620a is kept consistent with a direction of the pushing and ejecting force, to convert an elastic pushing force of the elastic member into a stable elastic pushing and ejecting force to output.

When the elastic member in a stretched state provides an elastic pushing and ejecting force, the elastic member can be stretched and disposed between the base 900 and the suspension member 610, and the reset direction of deformation of the elastic member 620a is kept consistent with a direction of the pushing and ejecting force, to convert an elastic pulling force of the elastic member into a stable elastic pushing and ejecting force to output.

In some embodiments, the elastic member is a spring and may be configured as a compression spring or a tension spring, to provide a stable pushing and ejecting force through a compressed deformation or a stretched deformation. The compression spring may be compressed between the suspension member 610 and the base 900, or the tension spring may be stretched and connected between the suspension member 610 and the base 900.

As shown in FIG. 6 and FIG. 7, a first end of the spring can be ejected and abutted against the ejecting-abutting portion 611. A boss portion 909 with a height substantially equal to that of the spring is disposed on the base 900. A second end of the spring can be ejected and abutted against the boss portion 909 to keep the spring in a straight posture in an axial direction thereof, to form a stable and reliable pushing and ejecting force.

The first end of the tension spring may be fixed on a body of the ejection-push member 610, or directly fixed on the ejecting-abutting portion 611, and the second end of the tension spring may be fixed on the boss portion 909 that is disposed on the base 900. The tension spring should be kept flush with a plate surface of the base 900 and in a straight posture as much as possible to form a stable and reliable push-out force.

In some embodiments, a support socket 908 may be further disposed below the boss portion 909 to limit and support the above springs, to ensure a stability of ejecting and abutting position of the springs and avoid shaking.

In some embodiments, the elastic member may also be an elastic member such as a torsion spring, a leaf spring, etc., as long as a direction of elastic force of the elastic member is roughly consistent with a moving direction of the suspension member 610, which will not be repeated here.

In some embodiments, in order to maintain a stability of moving direction of the suspension member 610 and limit an excessive swing and vibration of the suspension member 610, a suspension limit slide slot 906 may be disposed on the base 900, and the suspension member 610 may be disposed in the suspension limit slide slot 906. The stability of the moving direction of the suspension member 610 is maintained by a guiding and restraining effect of side walls of the suspension limit slide slot 906, to ensure a reliability of braking performance.

As shown in FIG. 6, in some embodiments, the suspension limit slide slot 906 may be configured as a gap between two opposite limit bosses 907. The limit bosses 907 may have a certain length in the moving direction of the suspension member 610, as long as the length can ensure that a limit for the suspension member 610 within a sliding stroke can be achieved. An upper limit structure may also be connected to a top of the two limit bosses 907 to limit the suspension member 610 from disengaging from the base 900 to a certain extent. A corresponding upper limit structure may also be disposed and covered on the base 900. The upper limit structure is opposite to the suspension limit slide slot 906 to achieve a purpose of upper limit. Thus, the suspension member 610 can always move in a stable direction to ensure a reliability of braking performance.

In some embodiments, in order to maintain the stability of the moving direction of the suspension member 610 and limit an unstable swinging of the suspension member 610, the suspension member 610 may be configured as rod-shaped, and the ejecting-abutting portion 611 is disposed at an end of the suspension member 610 which is close to the linkage wheel 300, that is, the suspension member 610 may be configured as a structural member with long strip shape having a certain length to cooperate with the suspension limit slide slot 906 to implement a stable sliding. A length characteristic of the long strip structural member and a radial limit effect of the suspension limit groove 906 on the long strip structural member can be utilized to reduce a swing amplitude to a certain extent. Generally speaking, the longer a length in a direction of the pushing and ejecting force of the suspension limit slide slot 906 and a length of the rod-shaped suspension member 610 are, the better a performance of limiting the swing amplitude is, and the more stable the moving direction of the suspension member 610 is.

As shown in FIG. 1 and FIG. 2, in some embodiments, the door rotation mechanism 400 may include a front connecting rod 410 and a rear connecting rod 420 which are hinged connections at ends. Another end of the front connecting rod 410 is rotatably connected to the door body 13 at a first connection point 431. The front connecting rod 410 is disposed between a bottom surface of the linkage wheel 300 and the base 900. The rear connecting rod 420 is deflectably disposed in a fix groove 329 which is formed on a top surface of the linkage wheel 300. Another end of the rear connecting rod 420 may be rotated coaxially with the rotation center 310 of the linkage wheel 300, and the rear connecting rod 420 and the linkage wheel 300 are connected to the base 900 at the rotation center 310 of the linkage wheel 300, that is, the rear connecting rod 420 can be rotated with the linkage wheel 300, and thus the front connecting rod 410 is pushed and pulled under pushes of a first abutting-holding surface 329a and a second abutting-holding surface 329b oppositely formed on groove walls of the fix groove 329 to rotate the door body 13, to implement operations of door opening and closing.

It is worth mentioning that the front connecting rod 410 and the rear connecting rod 420 are respectively disposed on two sides of the linkage wheel 300, that is, reserved spaces at two sides along a thickness direction of the linkage wheel 300 which is rotatably supported on the base 900 can be utilized for disposing the front connecting rod 410 and the rear connecting rod 420 respectively without occupying a space above the linkage wheel 300, to reduce a space requirement of the door rotation mechanism 400 in a thickness direction to a certain extent. The rear connecting rod 420 is sunken and disposed in the fix groove 329, to make an overall assembly height of the door rotation mechanism 400 and the linkage wheel 300 not be excessively higher than a height of the linkage wheel 300, and even be the same. Overall, a thickness of the door opening and closing device can be reduced by disposing the front connecting rod 410 and the rear connecting rod 420 at the two sides respectively and using the fix groove 329.

In some embodiments, the front connecting rod 410 and the rear connecting rod 420 can also be disposed in a space below the linkage wheel 300 and is located above the base 900. The fix groove 329 is also disposed on a bottom surface of the linkage wheel 300, to reduce an overall thickness of the door opening and closing device as a whole.

In some embodiments, the door body 13 and the box body 12 are rotatably connected at a first connection point 431. The front connecting rod 410 and the door body 13 are connected at a second connection point 432. The rear connecting rod 420 and the front connecting rod 410 are rotatably connected at a third connection point 433. The linkage wheel 300 has a rotation center 310. The second connection point 432 and the third connection point 433 are respectively located on two sides of a line connecting the first connection point 431 and the rotation center 310, and thus points of force application of two connecting rods are respectively located on two sides of the above-mentioned line. When deformation due to force occurs on the two connecting rods, deformation directions or trends of the two connecting rods will be in two opposite directions of a rod body, to avoid a deviation to a same side and maintain a balance at a stable interface. Thus, a stable structure for force application can be obtained, and an excessive deformation can be prevented from affecting an overall shape stability of the door opening and closing device.

As shown in FIG. 1, in some embodiments, the door opening and closing device is further provided with a door ejection mechanism 500. The door ejection mechanism 500 is connected to the linkage wheel 300, and ejects and pushes the door body 13 during the rotation of the linkage wheel 300, to break through an adsorption force between the door body 13 and the box body 12, to eject the door body 13 open, and thus a door-rotating difficulty of the door rotation mechanism 400 can be reduced. The suspension mechanism 600, the door ejection mechanism 500 and the door rotation mechanism 400 are located at a peripheral side of the linkage wheel 300. The suspension mechanism 600 and the door rotation mechanism 400 are located on two sides of the door ejection mechanism 500, to be reasonably distributed to reduce a space occupation and a risk of mutual interference.

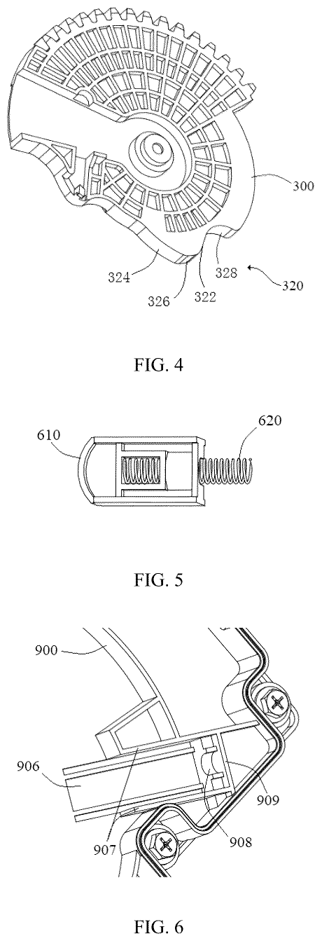

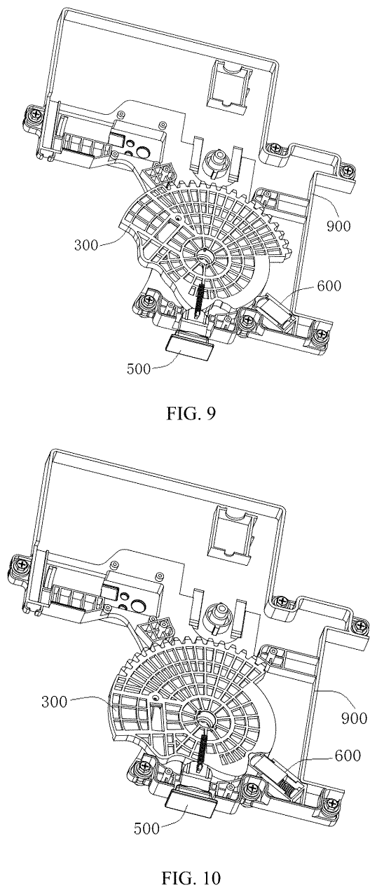

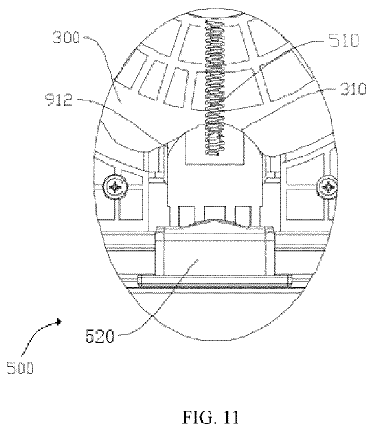

As shown in FIG. 4, FIG. 8, FIG. 9, FIG. 10 and FIG. 11, in some embodiments, the door ejection mechanism 500 may include a door ejection member 520. The door ejection member 520 may be movably disposed on the base 900. The limit groove 320 on the linkage wheel 300 is formed with a door ejection surface 322 therein. In a condition that a driving device drives the linkage wheel 300 to rotate, the door ejection surface 322 can be rotated with the linkage wheel 300, and push the door ejection member 520 to move relative to the base 900 to make the door ejection member to eject the door body 13 open.

It is worth mentioning that, with multiple functions of the limit groove 320 of the suspension mechanism, it can not only realize a suspension, braking and limiting, but also utilize shape characteristics of the limit groove 320 as a functional portion for ejecting and pushing the door ejection member 520 to simplify a structure of the linkage wheel 300.

In some embodiments, in a condition that the door body 13 is closed, an end of the door ejection member 520 is located in the limit groove 320, and the suspension mechanism 600 is abutted against and held on a peripheral surface of the linkage wheel 300. In a condition that the linkage wheel 300 is rotated, the linkage wheel 300 pushes, through the door ejection surface 322, the door ejection member 520 to move relative to the base 900 to push the door body 13, and then drives the door rotation mechanism 400 to continue to rotate the door body 13. An end of the suspension mechanism 600 slides along the peripheral surface of the linkage wheel 300, and thus when the suspension mechanism 600 slides into the limit groove 320, the suspension mechanism 600 is abutted against and held in the limit groove 320 to provide an acting force to brake the rotation of the linkage wheel 300.

In some embodiments of the disclosure, in order to improve a sealing effect between the door body 13 and the box body 12 when the door body 13 is closed on the box body 12, the door body 13 is usually pressed onto the box body 12 with a relatively large pressure, or the door body 13 is adsorbed onto the box body 12 through an adsorption structure. There is a larger adsorption force between the door body 13 and the box body 12, and thus a larger acting force is required for the door body 13 to be disengaged from the box body 12 when the door body 13 needs to be opened. In a condition that the linkage wheel 300 is rotated, the door ejection surface 322 can push the door ejection member 520 to move relative to the box body 12, to eject the door body 13 open. The door ejection surface 322 disposed on the linkage wheel 300 directly acts on the door ejection member to directly eject the door body 13 open. That is, the linkage wheel 300 can be driven by a driving structure to rotate, to make the door ejection member to eject the door body 13 open. Thus, the number of components of entire door opening and closing device can be reduced, and an integration of entire door opening and closing device can be improved. Stable direction and effect of ejecting-abutting force can be achieved.

In some embodiments, in a condition that the linkage wheel 300 is rotated, the door ejection member 520 cannot rotate with the linkage wheel 300, and the door ejection member 520 can move toward or away from the door body 13 under an action of the door ejection surface 322, to eject the door body 13 open. The door ejection member 520 can be attached to an outer surface of the door ejection surface 322. During the linkage wheel 300 is rotated, the door ejection member 520 moves along a profile of the outer surface of the door ejection surface 322 and moves in a direction approaching to or away from the door body 13 to eject the door body 13 open.

That is to say, in some embodiments of the disclosure, there is no direct connection relationship between the door ejection member 520 and the door ejection surface 322. The door ejection member 520 may be in contact with the door ejection surface 322, or may not be in contact with the door ejection surface 322. When a driving structure drives the linkage wheel 300 to rotate, the door ejection member 520 may be abutted against and held by the door ejection surface 322, and may be pushed by the door ejection surface 322 to move in a direction approaching to the door body 13 to eject the door body 13 open.

In other words, in some embodiments of the disclosure, the door ejection surface 322 is rotated with the linkage wheel 300, while the door ejection member 520 performs a linear motion, and thus the stable direction and effect of ejecting-abutting force can be achieved.

For the convenience of description, a rotation direction of the linkage wheel 300 that can open the door body 13 is defined as rotating forward. If the door opening and closing device receives a door opening signal, a driving structure drives the linkage wheel 300 to rotate forward, and the door rotation mechanism 400 can follow the linkage wheel 300 to rotate forward, to open the door body 13. If the door opening and closing device receives a door closing signal, the driving structure drives the linkage wheel 300 to rotate reversely, and the door rotation mechanism 400 can be rotated reversely with the linkage wheel 300, to close the door body 13.

As shown in FIG. 8, FIG. 9, FIG. 10 and FIG. 11, in some embodiments, in a condition that the door ejection surface 322 is rotated with the linkage wheel 300, the door ejection surface 322 abuts against and holds the door ejection member 520, and can push the door ejection member 520 to move relative to the base 900, to make the door ejection member 520 eject the door body 13 open.

The door ejection surface 322 may be disposed at a side of the limit groove 320 and opposite to the jointing surface 328. During the door ejection surface 322 is rotated with the linkage wheel 300, the door ejection surface 322 abuts against and holds the door ejection member 520, to make the door ejection member 520 move in a direction approaching to the door body 13, and the door ejection member 520 gradually extends out of the box body 12. As the linkage wheel 300 is rotated, the door ejection member 520 extends more and more out of the box body 12, to gradually eject the door body 13 open.

In some embodiments, the door ejection surface 322 is protruded on the linkage wheel 300, and thus distances from a rotation center of the linkage wheel 300 to various locations on the door ejection surface 322 are different. Since the distances from the rotation center 310 of the linkage wheel 300 to various locations on the door ejection surface 322 are different, during a rotation of the linkage wheel 300, the door ejection surface 322 abuts against and holds the door ejection member 520 to move in a direction approaching to the door body 13, to make the door ejection member gradually eject the door body 13 open.

In some embodiments, the door ejection surface 322 is gradually extended in a direction away from the rotation center of the linkage wheel 300. It can be understood that the door ejection surface 322 is inclined, and when the door body 13 is closed on the box body 12, the door ejection member 520 is disposed in the limit groove 320 and located at a jointing portion of the door ejection surface 322 and the peripheral surface of the linkage wheel 300, and is closest to the rotation center 310 of the linkage wheel 300. Since the door ejection surface 322 is protruded and inclined in a direction away from the rotation center 320 of the linkage wheel 300, when the linkage wheel 300 is driven by a driving structure to rotate, the door ejection surface 322 will abut against and hold the door ejection member 520 to move in a direction approaching to the door body 13, to make the door ejection member 520 gradually extend out of the box body 12, to eject the door body 13 open.

It is easily understood that an angle by which the door member 520 can open the door body 13 is related to a distance between the door ejection surface 322 and the rotation center 310 of the linkage wheel 300. For the convenience of description, a point on the door ejection surface 322 which is farthest from the rotation center 310 of the linkage wheel 300 is defined as the connection point 326. If the distance between the connection point 326 and the rotation center 310 of the linkage wheel 300 is farther, an extending length of the door ejection member 520 is longer, and the angle by which the door body 13 to be opened is larger.

In some embodiments, the door ejection member 520 can eject the door body 13 open by an angle of 3 degrees to 5 degrees. The angle can be flexibly set according to an angle required to break through a door-opening resistance force of the door body 13.

During a process in which the door body 13 is ejected open through the door ejection surface 322, the door body 13 may have been ejected open through a middle portion of the door ejection surface 322, and thus the door body 13 can be opened by a smaller angle to facilitate the door rotation mechanism 400 to continue opening the door body 13 during a continuous rotation of the linkage wheel 300.

As shown in FIG. 4, in some embodiments, the peripheral surface of the linkage wheel 300 further includes an avoidance surface 324. The avoidance surface 324 is connected to the door ejection surface 322. After the door ejection member is disengaged from abutting and holding with the door ejection surface 322, the elastic reset member 510 can be reset and follow the avoidance surface 324.

In a direction of forward rotation of the linkage wheel 300, the door ejection surface 322 is disposed in front of the avoidance surface 324, that is, in a process of rotation of the linkage wheel 300, the door ejection surface 322 first contacts the door ejection member 520, to eject and abut against the door ejection member 520 to move in a direction approaching to the door body 13. After the door ejection member 520 is disengaged from ejecting and abutting with the door ejection surface 322, the door ejection member 520 can contact the avoidance surface 324, to enable the door ejection member 520 to move in a direction away from the door body 13. Thus, the door ejection member 520 after ejecting the door body 13 open, can be retracted onto the box body 12 to facilitate subsequent closing of the door.

It is easily understood that if the linkage wheel 300 is not provided with the avoidance surface 324 thereon, after the door ejection member 520 ejects the door body 13 open, the door ejection member 520 always extends out of the box body 12. When the door body 13 needs to be closed, the door ejection member 520 is located outside the box body 12 and will interfere with the door body 13, and thus the door body 13 cannot be closed. Therefore, a main purpose of providing the avoidance surface 324 is to provide the door ejection member 520 with a space to be retracted onto the box body 12 after the door ejection member 520 ejects the door body 13 open. Thus, the door ejection member 520 can be retracted onto the box body 12 after the door ejection member 520 ejects the door body 13 open, to avoid the door body 13 from being unable to be retracted.

In an embodiment, after the door ejection surface 322 ejects and abuts against the door ejection member to an outside of the box body 12 and when the avoidance surface 324 is rotated to a rear of the door ejection member 520, the door ejection member 520 cannot automatically return to an original position and cannot automatically follow the avoidance surface 324 to be retracted onto the box body 12. An elastic member 510 may be disposed on the base 900 and the door ejection member 520. The door ejection member 520 can be retracted onto the box body 12 through a restoring force of the elastic member 510.

In a process of the door ejection surface 322 ejecting and abutting against the door ejection member 520, the elastic member 510 is gradually deformed. When the connection point 326 contacts the door ejection member 520, a deformation of the elastic member 510 reaches the maximum. In a process of the driving structure driving the linkage wheel 300 to continue to be rotated, the door ejection member 520 is disengaged from abutting and holding with the door ejection surface 322. After the disengagement, the avoidance surface 324 provides a space for the door ejection member to be retracted onto the box body 12. The door ejection member 520, under an action of the restoring force of the elastic member 510, moves in the direction away from the door body 13, to enable the entire door ejection member 520 to be retracted onto the box body 12, to facilitate a closing of the door body 13.

In some embodiments, the elastic member 510 may be a spring or a torsion spring, either one of which may be selected.

In a condition that the elastic member 510 is a spring, an end of the spring is connected to the door ejection member 520, and another end of the spring may be fixed on the base 900 or may be fixed on a connecting shaft of the linkage wheel 300. In some embodiments, a rotating shaft is fixedly connected to the base 900. That is to say, an end of the spring away from the door ejection member is required to be connected to a fixed structure.

If the elastic member 510 is a spring, the spring is gradually stretched during the process of the door ejection surface 322 ejecting and abutting against the door ejection member 520. The spring reaches a maximum stretched amount when the connection point 326 contacts the door ejection member 520. In a process of the driving structure driving the linkage wheel 300 to continue to be rotated, the door ejection member 520 is disengaged from abutting and holding with the door ejection surface 322. After the disengagement, the avoidance surface 324 provides a space for the door ejection member 520 to be retracted onto the box body 12. The door ejection member 520, under an action of the restoring force of the spring, moves in the direction away from the door body 13, to enable the entire door ejection member 520 to be retracted onto the box body 12, to facilitate a closing of the door body 13.

If the elastic member 510 is a torsion spring, a middle portion of the torsion spring and a first end of the torsion spring are disposed on the base 900, and a second end of the torsion spring is connected to the door ejection member 520. In some embodiments, the middle portion of the torsion spring is connected to the first end and the second end respectively. When the door ejection member 520 ejects the door body 13 open, the door ejection member 520 needs to overcome a torsion force of the torsion spring.

If the elastic member 510 is a torsion spring and when the door ejection member is ejected and abutted against by the door ejection surface 322 to move in a direction approaching to the door body 13, the torsion spring is twisted. After the door ejection member 520 is disengaged from abutting and holding with the door ejection surface 322, the door ejection member 520, under the action of the restoring force of the torsion spring, can follow the avoidance surface 324 to move in the direction away from the door body 13, to enable the door ejection member 520 to be reset to avoid an interference of the door ejection member 520 and the door body 13, and to facilitate a door closing.

In some embodiments, the door ejection surface 322 and the avoidance surface 324 are connected at the connection point 326. A distance between the connection point 326 and the rotation center 310 of the linkage wheel 300 is greater than a distance from any point on the avoidance surface 324 and the door ejection surface 312 to the rotation center 310 of the linkage wheel 300.

In some embodiments, the door ejection surface 322 and the avoidance surface 324 are connected to each other. A point where the door ejection surface 322 and the avoidance surface 324 are connected can be defined as the connection point 326. The connection point 326 is a point on the door ejection surface 312 and the avoidance surface 324 that is farthest from the rotation center 310 of the linkage wheel 300. In a condition that the connection point 326 ejects and abuts against the door ejection member 520, the door ejection member 520 ejects the door body 13 to open by a maximum angle. When the avoidance surface 324 is rotated to a rear of the door ejection member 520, the avoidance surface 314 provides the door ejection member 520 with a space for moving away from the door body 13, to enable the door ejection member 520 to be retracted onto the box body 12, to be convenient for subsequent closing of the door.

It is easily understood that, in a process of the door ejection surface 322 ejecting and abutting against the door ejection member 520, the door body 13 is gradually opened. It is not that the door body 13 is opened by the door ejection member 520 only at a time when the connection point 326 is in contact with the door ejection member 520. In a process of the door ejection surface 322 rotating with the linkage wheel 300, it is possible that when one of points on the door ejection surface 322 ejects and abuts against the door ejection member 520, the door ejection member 520 ejects the door body 13 open. It is only when the connection point 326 ejects and abuts against the door ejection member 520, the door body 13 in a door ejection stage reaches the maximum opening.

A speed of ejecting door of the door ejection member 520 is related to a rotation speed of the linkage wheel 300 which is driven by the driving structure. The faster the linkage wheel 300 is rotated, the faster the door ejection member 520 ejects the door body 13 open. If the rotation speed of the linkage wheel 300 is slower, the speed at which the door ejection member 520 ejects the door body 13 open will be slower.

In some embodiments, the avoidance surface 324 and the door ejection surface 322 may be cambered surfaces or inclined planes.

It should be noted that, in some embodiments, an end of the door rotation mechanism 400 is connected to the linkage wheel 300, and another end of the door rotation mechanism 400 is connected to the door body 13. The door ejection member 520 and the door rotation mechanism 400 can be driven by a same driving structure and linkage wheel 300 to realize functions of ejecting the door and opening the door. The door ejection member 520 first ejects the door body 13 open by a smaller angle, and the door rotation mechanism 400 then further opens the door body 13.

As shown in FIG. 11, in some embodiment, a mounting groove 912 is disposed on the base 900. The door ejection member 520 is movably disposed in a mounting groove 912. The mounting groove 912 is in a shape of an elongated strip. Since the door ejection member 520 is disposed in the mounting groove 912, the door ejection member 520 can move along an extending direction of the mounting groove 912, to enable the door ejection member 520 to move closer to or away from the door body 13.

In some embodiments, the extending direction of the mounting groove 912 may be from the linkage wheel 300 to the door body 13. In order to reduce a loss of a door ejection force when the door ejection member 520 is ejecting the door, the mounting groove 912 may be perpendicular to the door body 13 when the door body 13 is closed.

In some embodiments, the door ejection surface 322 and the linkage wheel 300 are integrally formed. The door ejection surface 322 and the linkage wheel 300 are integrally formed, it is equivalent to the linkage wheel 300 directly interacting with the door ejection member 520, to be capable of reducing the number of other components and reducing structures of the door opening and closing device 11 to decrease an occupied space.

In some embodiments, the linkage wheel 300 is driven by the driving structure to rotate. The rotation of the linkage wheel 300 can be converted into a movement of the door ejection member 520 by providing the door ejection surface 322. The door can be ejected by providing the linkage wheel 300 before the door is opened, and thus an application range of the linkage wheel 300 is increased, a driving structure for the door ejection member 520 is reduced. Thus, structures of the door opening and closing device 11 are decreased and the occupied space is reduced.

In conclusion, the door opening and closing device 11 is provided according to some embodiments of the disclosure. In order to improve a sealing effect between the door body 13 and the box body 12 when the door body 13 is closed on the box body 12, the door body 13 is usually pressed onto the box body 12 with a relatively large pressure, or the door body 13 is adsorbed onto the box body 12 through an adsorption structure. There is a larger adsorption force between the door body 13 and the box body 12, and thus a larger acting force is required for the door body 13 to be disengaged from the box body 12 when the door body 13 is opened. A door ejection surface 322 is disposed on the linkage wheel 300. When the linkage wheel 300 is rotated, the door ejection surface 322 can push the door ejection member to move relative to the box body 12, to eject the door body 13 open. The door ejection surface 322 disposed on the linkage wheel 300 directly acts on the door ejection member 520 to directly eject the door body 13 open. That is, the linkage wheel 300 can be driven by a driving structure to rotate, to make the door ejection member 520 eject the door body 13 open. Thus, the number of components of entire door opening and closing device can be reduced, and an integration of entire door opening and closing device can be improved.

The door opening and closing device according to the embodiment of the disclosure realizes an automatic opening and closing of door by driving the door rotation mechanism to rotate the door body 13 through the linkage wheel which can be driven by a driving device. The linkage wheel 300 is rotated forward and reversely to drive the door rotation mechanism 400 to act to push and pull the door body 13, to implement the opening and closing of door. A limit groove 320 is disposed on the linkage wheel 300 to match with the suspension mechanism 600 disposed on the base 900 to form a functional suspension structure which serves as a functional structure for braking the linkage wheel 300. The suspension mechanism 600 tracks positions of rotating peripheral surface of the linkage wheel 300. In a condition that the linkage wheel 300 is rotated to a preset suspension position, the suspension mechanism 600 is abutted against and held in the limit groove 320 to lock the linkage wheel 300 on the base 900 to realize a braking of the linkage wheel, to brake the door rotation mechanism 400 connected to the linkage wheel 300. Thus, a suspension of the door body 13 is realized. An opening stability of the door body 13 is ensured. Thus, it is easy to use while a door-opening difficulty is reduced. A risk of collision is reduced. At the same time, the limit groove 320 has the multiple functions, and a door ejection surface 322 and a door ejection mechanism 500 are provided. During the rotation of the linkage wheel 300, the door ejection mechanism 500 is ejected and pushed to push a movement of the door body, to break through door-opening resistance forces such as an adsorption force of the door body 13 and the like. Thus, it is convenient for the door rotation mechanism 400 to rotate the door body 13 and reduce the door opening and closing difficulty.

In addition, the various embodiments can be combined with one another, but the combined embodiments must be based on that they can be implemented. When the combined embodiments are contradictory or cannot be realized, it should be considered that such combined embodiments do not exist, and are not within the protection scope sought for by the present disclosure.

Although embodiments of the disclosure have been shown and described, it will be appreciated that various changes, modifications, substitutions and alterations may be made to the embodiments without departing from the principles and spirit of the disclosure, the scope of which is defined by the claims and equivalents thereof.

1. A door opening and closing device, comprising:
a driving mechanism comprising a linkage wheel, the linkage wheel being rotatably disposed on a base, a limit groove being disposed on a peripheral surface of the linkage wheel, the limit groove having a door ejection surface along a direction of the peripheral surface of the linkage wheel;
a door rotation mechanism connected to the linkage wheel and a door body;
a door ejection mechanism comprising a door ejection member movably disposed on the base;
a suspension mechanism movably disposed on the base;
wherein, in a condition that the door body is closed, an end of the door ejection member is located in the limit groove, and the suspension mechanism is abutted against and held on the peripheral surface of the linkage wheel,
in a condition that the linkage wheel is rotated, the linkage wheel pushes, through the door ejection surface, the door ejection member to move relative to the base to push the door body, and then drives the door rotation mechanism to continue to rotate the door body, wherein an end of the suspension mechanism slides along the peripheral surface of the linkage wheel, and thus when the suspension mechanism slides into the limit groove, the suspension mechanism is abutted against and held in the limit groove to provide an acting force to brake the rotation of the linkage wheel.

2. The door opening and closing device according to claim 1, wherein the suspension mechanism comprises a suspension member and an ejection-push member;
the ejection-push member is disposed on the base and the suspension member is movably disposed on the base wherein the suspension member is connected to the ejection-push member, and an ejecting-abutting portion that is disposed on the suspension member abuts against the linkage wheel;
in a condition that the linkage wheel is rotated to a state in which the limit groove is opposite to the suspension mechanism, the ejection-push member pushes the suspension member to move, to make the ejecting-abutting portion to be ejected and abutted into the limit groove.

3. The door opening and closing device according to claim 2, wherein a push-ejection limit slot is formed on the suspension member, the ejection-push member being disposed in the push-ejection limit slot, the ejection-push member being connected to the ejecting-abutting portion.

4. The door opening and closing device according to claim 2, wherein the suspension member is provided with an ejecting-abutting portion and a connecting portion thereon, the ejecting-abutting portion ejecting and abutting against the linkage wheel, the connecting portion being connected to the ejection-push member.

5. The door opening and closing device according to claim 3, wherein the ejection-push member is an elastic member, an end of the elastic member being connected to the base, another end of the elastic member being connected to the suspension member, the elastic member being elastically compressed or stretched between the base and the suspension member.

6. The door opening and closing device according to claim 5, wherein a suspension limit slide groove is formed on the base, the suspension member being slidably embedded in the suspension limit slide groove, and wherein the elastic member is disposed in the suspension limit slide groove, with an end ejecting and abutting against the base and another end ejecting and abutting against the suspension member.

7. The door opening and closing device according to claim 6, wherein the suspension member is rod-shaped, and is formed with the ejecting-abutting portion on an end.

8. The door opening and closing device according to claim 5, wherein the elastic member is a spring.

9. The door opening and closing device according to claim 1, wherein the limit groove is C-shaped or V-shaped.

10. The door opening and closing device according to a claim 1, wherein the door rotation mechanism-comprises a front connecting rod and a rear connecting rod which are hinged at ends, another end of the front connecting rod being connected to the door body, another end of the rear connecting rod-being deflectably disposed in a mounting groove which is formed on the linkage wheel, and wherein the linkage wheel is driven to rotate by the driving mechanism to drive the rear connecting rod to push or pull the front connecting rod to push or pull the door body.

11. The door opening and closing device according to claim 10, wherein the front connecting rod is located between a bottom surface of the linkage wheel and the base, the rear connecting rod being located in the mounting groove which is located on a top surface of the linkage wheel, or wherein the mounting groove is located on a bottom surface of the linkage wheel, the front connecting rod and the rear connecting rod being both located between the bottom surface of the linkage wheel and the base.

12. The door opening and closing device according to claim 11, wherein the door body and a box body are rotatably connected at a first connection point, and wherein the front connecting rod and the door body are connected at a second connection point, and wherein the rear connecting rod and the front connecting rod are rotatably connected at a third connection point, the linkage wheel having a rotation center the second connection point and the third connection point being respectively located on two sides of a line connecting the first connection point and the rotation center.

13. The door opening and closing device according to claim 1, wherein the door ejection surface is gradually extended in a direction away from a rotation center of the linkage wheel.

14. The door opening and closing device according to claim 13, wherein an avoidance surface is further provided on the peripheral surface of the linkage wheel, the avoidance surface being connected to the door ejection surface, and wherein after the door ejection member is disengaged from abutting and holding with the door ejection surface, the door ejection member is able to be reset and follow the avoidance surface.

15. The door opening and closing device according to claim 14, wherein the door ejection surface and the avoidance surface are connected at a connection point, and wherein a distance between the connection point and the rotation center of the linkage wheel is greater than a distance from any point on the avoidance surface and the door ejection surface-to the rotation center of the linkage wheel.

16. The door opening and closing device according to claim 15, further comprising an elastic member, wherein the elastic member is connected between the base and the door ejection member, and wherein in a condition that the door ejection member is out of cooperation with the door ejection surface, the elastic member is able to drive the door ejection member to follow a movement of the avoidance surface, and is able to reset the door ejection member.

17. The door opening and closing device according to claim 16, wherein the elastic member is one of a spring and a torsion spring.

18. The door opening and closing device according to claim 13, wherein a mounting groove is disposed on the base, the door ejection member being movably disposed in the mounting groove.

19. An electrical apparatus, comprising:
a box body, a door body, and the door opening and closing device, comprising:
a driving mechanism comprising a linkage wheel, the linkage wheel being rotatably disposed on a base, a limit groove being disposed on a peripheral surface of the linkage wheel, the limit groove having a door ejection surface along a direction of the peripheral surface of the linkage wheel;
a door rotation mechanism connected to the linkage wheel and a door body;
a door ejection mechanism comprising a door ejection member movably disposed on the base;
a suspension mechanism movably disposed on the base;
wherein, in a condition that the door body is closed, an end door ejection member is located in the limit groove, and the suspension mechanism is abutted against id held on the peripheral surface of the linkage wheel;
in a condition that the linkage wheel is rotated, the linkage wheel pushes, through the door ejection surface, the door ejection member to move relative to the base to push the door body, and then drives the door rotation mechanism to continue to rotate the door body, wherein an end of the suspension mechanism slides along the peripheral surface of the linkage wheel, and thus when the suspension mechanism slides into the limit groove, the suspension mechanism is abutted against and held in the limit groove to provide an acting force to brake the rotation of the linkage wheel;
the door body is rotatably connected to the box body, and the door opening and closing device is connected to the box body and is connected to the door body, to open or close the door body and achieve a suspension of the door body when rotating to a preset position.
